(19) United States
(12) Patent Application Publication
(10) Pub. No.: US 2009/0319635 A1
(43) Pub. Date: Dec. 24, 2009

(54) CENTRALLY MANAGED INVENTORY AND ENTITLEMENT DATA

(75) Inventors: Thomas D. Christopherson, Rochester, MN (US); Bradley A. Goss, Loveland, CO (US); Randy L. Grimm, Rochester, MN (US); Kevin W. Kirkeby, Rochester, MN (US); Mark A. Pasch, Rochester, MN (US); Richard M. Smith, Oronoco, MN (US)

Correspondence Address: IBM-Rochester c/o Toler Law Group, 8500 Bluffstone Cove, Suite A201, Austin, TX, 78759, US

(73) Assignee: INTERNATIONAL BUSINESS MACHINES CORPORATION, Armonk, NY (US)

(21) Appl. No.: 12/486,935

(22) Filed: Jun. 18, 2009

Related U.S. Application Data
(60) Provisional application No. 61/073,967, filed on Jun. 19, 2008.

(51) Int. Cl. G06F 15/16

(52) U.S. Cl. 709/217; 709/224

(57) ABSTRACT

A method, apparatus and program product manages application entitlement data by storing entitlement data received from a plurality of application providers. Inventory data associated with a networked computing device or an application executable on the networked computing device is monitored. Delivery of the entitlement data to the networked computing device is enabled according to the inventory data.

### RELATED APPLICATIONS

The present application claims priority to U.S. Provisional Patent Application No. 61/073,967 filed on Jun. 19, 2008 and entitled “CENTRALLY MANAGED SOFTWARE INVENTORY AND ENTITLEMENT.”

### FIELD OF THE DISCLOSURE

The present disclosure generally relates to computers and computer applications, and more particularly, to systems and processes for maintaining application and other entitlements.

### BACKGROUND OF THE DISCLOSURE

Most commercial and government organizations depend heavily upon computers. A software or hardware failure can pose a serious hardship to an organization. Problems stemming from such system failures can be exacerbated where license keys and other entitlement data are involved.

Entitlement data generally includes data used to validate and enable computer applications. A system administrator initially installs the entitlement data received from different application providers onto select system servers. For example, the administrator enters license keys into the appropriate applications and subsequently maintains updates and renewals that concern the entitlement data.

After a system failure, the administrator reinstalls and verifies entitlement assignments. Such reconstitution processes can present organizational and time challenges to administrators. For example, the administrator may have to contact multiple application providers to reacquire the requisite license keys. Even during times of normal operation, the management of entitlement data can be complex and burdensome to administrators. For example, the addition of a hardware device can result in a need to update a license key and other entitlement data.

There is consequently a need for a more effective manner of managing entitlement data.

### SUMMARY OF THE DISCLOSURE

The present disclosure provides an apparatus, program product and method of managing entitlement data. The method includes storing entitlement data received from a plurality of application providers and receiving inventory data associated with at least one of a networked computing device and an application executable on the networked computing device. The method further includes enabling delivery of the entitlement data to the networked computing device according to the inventory data.

According to another aspect of an embodiment, an apparatus includes a memory configured to store entitlement data received from a plurality of application providers. At least a portion of the entitlement data is configured to enable an application executable on a networked computing device. The memory is further configured to store inventory data associated with the networked computing device. The apparatus further includes program code resident within the memory and a processor in communication with the memory. The processor is configured to execute the program code to enable delivery of the entitlement data to the networked computing device according to the inventory data.

According to another aspect of an embodiment, a program product includes program code configured to receive entitlement data from a plurality of application providers. At least a portion of the entitlement data is configured to enable an application executable on a networked computing device. The program code is further configured to enable delivery of the entitlement data to the networked computing device according to inventory data associated with the networked inventory device. The program product further includes a computer readable medium bearing the program code.

According to another aspect of an embodiment, an apparatus includes a plurality of application provider computers each including entitlement data configured to enable at least one of a plurality of applications. The apparatus further includes a client computer having inventory data and an application. The apparatus further includes a central server computer configured to monitor the inventory data and to receive the entitlement data from the plurality of application providers. The central server computer is further configured to enable delivery of stored entitlement data configured to enable the application from the central server computer to the networked computing device.

According to an aspect of an embodiment, license keys and entitlement information from various application providers may be managed identically, leading to increased efficiency and other economies. Notifications to customers and application providers concerning entitlement renewal may be automated. During a recovery, a replacement (e.g., DASD replacement), or a hardware migration scenario, entitlement information and license keys may be automatically restored to their previous state, or the entitlement data and license keys may be regenerated and reapplied. Keys for service terms, hardware upgrades and other changes may be automatically validated.

These and other advantages and features that characterize an embodiment of the invention are set forth in the claims annexed hereto and forming a further part hereof. However, for a better understanding of the invention, and of the advantages and objectives attained through its use, reference should be made to the Drawings and to the accompanying descriptive matter in which there are described exemplary embodiments of the invention.

### BRIEF DESCRIPTION OF THE DRAWINGS

FIG. 1 shows a block diagram of an embodiment of a networked computer system configured to manage inventory data associated with a networked computing device and entitlement data from a plurality of application providers;

FIG. 2 shows a block diagram of another embodiment of a networked computer system configured to manage entitlement data from a plurality of application providers;

FIG. 3 illustrates a logic diagram that represents a logical relationship between networked computing devices, application providers having entitlement data for enabling applications on the networked computing devices and a central server computer that maintains the entitlement data;

FIG. 4 illustrates a diagram that shows a data model having logically linked data stored within an inventory repository and an entitlement warehouse of a central server, such as the central server computer of FIG. 2;

FIG. 5 illustrates a flow chart of a particular method of an embodiment configured to manage inventory data and entitlement data for a plurality of client and application provider computers; and

FIG. 6 illustrates a flow chart of an embodiment of a method configured to automatically manage entitlement data from a plurality of application providers.

### DETAILED DESCRIPTION

Aspects of the present invention may include a central server and repository to manage application entitlement data by storing entitlement data received from a plurality of application providers. Inventory data, such as installation and operational status data associated with a client computing device or with an application executable on the client computing device, may be automatically and periodically monitored. Installation data may generally include indicate whether or not entitlement data is installed, when it was installed, and a specific level (i.e., version/release and fix level) of the software or firmware that is installed. The central server and repository may thus be aware of the operational status of the hardware and software included within the client computing system.

When there is a detected change to the inventory data, such as an addition of a computing device or an application user, the central server may prompt the appropriate application provider to update the entitlement data. The application provider may provide the updated entitlement data based on the change to the central server and repository. The central server and repository may then make the updated entitlement data available to be imported automatically by the client computing device. The entitlement management process may occur without requiring client interaction or knowledge. According to an embodiment, an application provider may automate the entitlement management process using web services and APIs provided by the central server and repository.

Aspects may provide a central server and repository configured to store details of the customer inventory and to automatically manage entitlement data associated with the inventory. Each application component may be associated with entitlement data provided by an application provider to the central server and repository. The entitlement data is made available by the central server and repository to the client. The client may map applications to specific hardware assets. If application entitlements and license keys are based on hardware assets, the client may then import the entitlement data into the applications installed on a client server.

According to a particular embodiment, an application provider may provide entitlement data to the central server and repository after a purchase of an application. The entitlement data may be stored in a repository with other entitlement data previously provided by the same and other application providers. The same commercial entity that manages the central server and repository may also provide applications to the client. In another example, the commercial entity that manages the central server and repository may also monitor the inventory data of the client networked computing device. The entitlement data may provide a trigger mechanism to automatically fulfill and install the application.

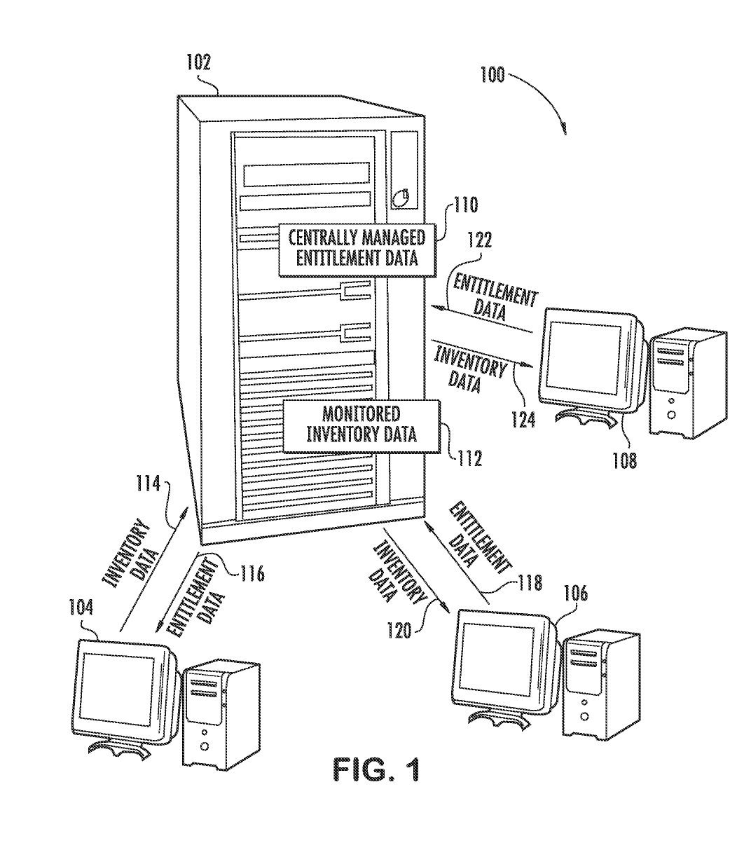

Turning now to the Drawings, wherein like numbers denote like elements throughout the several views, FIG. 1 illustrates a networked computer system, or apparatus 100, configured to manage inventory data of a networked computing device and entitlement data from a plurality of application providers. The apparatus 100 includes a central server and repository 102 networked to a client computer, or a networked computing device 104. The apparatus 100 further includes a first application provider computer 106 and a second application provider computer 108 networked to the central server and repository 102.

The central server and repository computer 102 may be configured to monitor via communications link 114 inventory data associated with the networked computing device 104. For example, the central server and repository computer 102 may monitor an operational status, e.g., installation data, associated with a hardware or software component of the networked computing device 104. Installation data may relate to a hardware configuration, a number of application users, an installed application, a host name, an IP address, a serial number, and a number of processors, among other data. The central server and repository computer 102 may further be configured to receive entitlement data via communication links 118, 122 from both of the application provider computers 106, 108. The entitlement data may be used to enable an application resident on the networked computing device 104.

The entitlement data may include a license key, or a product key, used to enable the application. The license key may include a specific software-based key used to identify that a copy of an application is an original. License keys typically include a sequence of alphanumeric or binary characters. The sequence may be manipulated using a mathematical formula in order to match results to an expected value. The entitlement data may further include entitlement information. Entitlement information may include information in electronic form that demonstrates that a user has purchased an application, e.g., registration information. Entitlement information may also include maintenance and license term information.

The central server and repository computer 102 may further be configured to enable delivery via a communications link 116 of the stored entitlement data to the networked computing device 104. For example, the central server and repository computer 102 may grant permissions or otherwise facilitate the importation of the entitlement data by the networked computer device 104.

The inventory data may include a serial number or other hardware identification data, as well as an operational status of a hardware or application component. For example, inventory data may indicate whether a hardware or software component has been added, removed, or failed. In a particular embodiment, the inventory data may include data used to monitor the operating status, e.g., installation data, of the networked computing device 104. A commercial entity tasked with maintaining the hardware and software of the networked computing device 104 may monitor the inventory data as part of maintaining operation of the networked computing device 104.

For example, when a fault occurs on the networked computing device 104, program code executing on either or both the networked computing device 104 and the central server and repository 102 may automatically gather operational status data associated with the fault. The central server and repository 102 may analyze the inventory data to provide a solution to the user, such as fault recovery data, at the networked computing device 104.

Other inventory data may include an assignment of an entitlement to a hardware component, an application, or a user. For example, an administrator at the networked computing device 104 may assign entitlement data to an application resident on the networked computing device 104. The serial number or other application product identifier may be communicated using the link 114 to the central server and repository 102, along with other inventory data. Some or all of the inventory data communicated via the link 114 to the central server and repository 102 may be forwarded using a link 120, 124 to the application provider 106, 108 associated with the entitlement data.

The networked computing device 104 may include a standalone computing device or a networked plurality of computers. Similarly, the central server and repository 102 may include a computer, a computer system or other programmable electronic device. Moreover, each computer 102, 104 may be implemented using one or more networked computers, e.g., in a cluster or other distributed computing system. In the alternative, each computer 102, 104 may be implemented within a single computer or other programmable electronic device.

FIG. 1 thus shows an embodiment of a networked computing system 100 having a central sever and repository 102 configured to manage application entitlement data by storing entitlement data received from a plurality of application providers. Inventory data associated with a networked computing device 104 or an application executable on the networked computing device 104 may be monitored. The delivery of the entitlement data to the networked computing device 104 may be enabled based on the inventory data to facilitate more efficient entitlement management and seamless entitlement recovery.

For example, the central server and repository 102 may automatically make entitlements available to applications on the networked computing device 104 in response to a detected system fault. A networked computing device 104 may further automatically reacquire entitlement data after a hardware migration or DASD replacement associated with the networked computing device 104. The central server and repository 102 may access the centrally managed entitlement data 110 and the monitored inventory data 112 to restore the state of the entitlements to that of the pre-fault state. In one example, the application provider may regenerate entitlement data for the networked computing device to automatically reacquire.

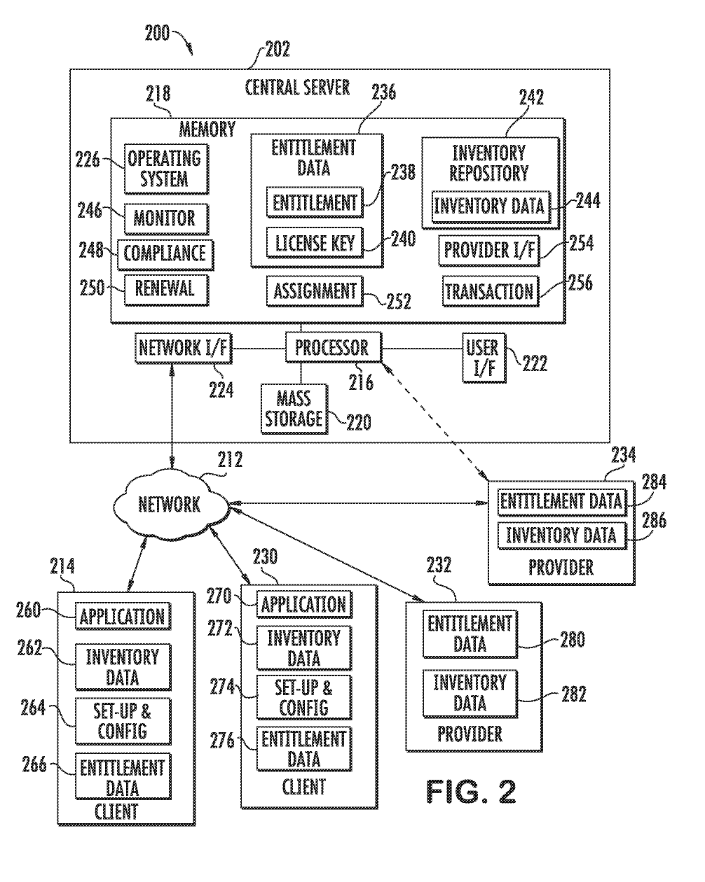

FIG. 2 illustrates a particular embodiment of another apparatus, or computer system 200, configured to manage entitlement data from a plurality of application providers. The computer system 200 in the illustrated embodiment is implemented as a server or multi-user computer system including a central server 202 that is coupled via a network 212 to client computers 214, 230 and application provider computers 232, 234. An application provider computer may represent any provider of an entitlement and an associated license key, e.g., hardware or service-related. Each computer 214, 230, 232, 234 may represent a computer, a computer system or other programmable electronic device. Moreover, each computer 214, 230, 232, 234 may be implemented using one or more networked computers, e.g., in a cluster or other distributed computing system. In the alternative, each computer 214, 230, 232, 234 may be implemented within a single computing or other programmable electronic device, such as a desktop computer, a laptop computer, a handheld computer, a cell phone, a set top box, a non-networked, standalone configuration, etc.

The central server 202 typically comprises a central processing unit, or processor 216, that includes at least one microprocessor coupled to a memory 218. The central server 202 may be similar to the central server and repository 102 of FIG. 1. The memory 218 may represent the random access memory (RAM) devices comprising the main storage of the central server 202, as well as any supplemental levels of memory: cache memories, non-volatile or backup memories (programmable or flash memories), read-only memories, etc. In addition, the memory 218 may be considered to include memory storage physically located elsewhere in the central server and repository 202, e.g., any cache memory in the processor 216, as well as any storage capacity used as a virtual memory, as stored on a mass storage device 220 or on another computer coupled to the central server 202.

The central server 202 also typically receives a number of inputs and outputs for communicating information externally. To interface with a user or operator, the computer 202 typically includes a user interface 222 incorporating one or more user input devices (e.g., a keyboard, a mouse, a trackball, a joystick, a touchpad, and/or a microphone, etc.) and a display (e.g., a CRT monitor, an LCD display panel, and/or a speaker, etc.) User input may also be received via another computer or terminal.

For additional storage, the central server 202 may also include one or more mass storage devices 220, such as a floppy or other removable disk drive, a hard disk drive, a direct access storage device (DASD), an optical drive (a CD drive, a DVD drive, etc.), and/or a tape drive, among others. Furthermore, the central server 202 may include a network interface 224 with one or more networks 212 (e.g., a local area network, a wide area network, a wireless network, and/or the Internet, etc.) to permit the communication of information with other computers and electronic devices. It should be appreciated that the central server 202 typically includes suitable analog and/or digital interfaces between the processor 202 and each of the components 218, 220, 222 and 224 as is well known in the art. Other hardware environments are contemplated within the context of the invention.

The central server 202 may operate under the control of an operating system 226 and may execute or otherwise rely upon various computer software applications, components, programs, objects, modules, data structures, etc., as will be described in greater detail below. Moreover, various applications, components, programs, objects, modules, etc. may also execute on one or more processors in another computer coupled to the central server 202 via the network 212, e.g., in a distributed or client-server computing environment, whereby the processing required to implement the functions of a computer program may be allocated to multiple computers over a network.

As shown in FIG. 2, the memory 218 also includes entitlement data 236. Entitlement data generally includes data used to enable an application. For example, the entitlement data 236 in FIG. 2 includes entitlement information 238 and a license key 240. The license key 240 may include a specific software-based key used to identify that a copy of an application is original. The entitlement information 238 may include information in electronic form that demonstrates that a user has purchased an application, e.g., registration information. Entitlement information may also include maintenance and license term information, as well as service-level information. Examples of service-level information may include what features are enabled and how many users are allowed.

A provider interface 254 may allow an application provider 232, 234 to access entitlement data associated with the application provider 232, 234. For example, an application provider 232, 234 may be allowed to view and modify entitlement assignments, e.g., to update what entitlement data has been assigned to which application. The provider interface 254 may further restrict access of an application provider 232, 234 to their own data.

A transaction algorithm 256 may receive and process information associated with inventory or entitlement updates, such as an acquisition of an application by a client computer 214, 230. The transaction algorithm 256 may use such information to update the inventory data 244.

The memory 218 also includes an inventory repository 242. The inventory repository 242 may maintain inventory data 244. Examples of inventory data 242 may include a hardware identifier, such as a serial number. Other examples of inventory data 242 may relate to a network, as well as features and capabilities of the platform. The inventory data 242 may further include a status of the networked computing device, an application, or a user assigned to the application or the networked computing device. Inventory data may also include assignment information associating the entitlement data with the application, a user, or the networked computing device.

A monitor algorithm 246 may monitor the inventory data 262, 272 of the client computers 214, 230. For example, the monitor algorithm 246 may determine the operational status of a hardware or software component of the client computers 214, 230. The monitor algorithm 246 may send notifications back to an application provider 232, 234 in response to a change in client inventory data 262, 272. A similar or complimentary monitor algorithm (not shown) may be present on the client computers 214, 230.

A renewal algorithm 250 may automatically determine a renewal status associated with an entitlement. For example, the renewal algorithm 250 may determine if an entitlement is nearly ready for renewal. The renewal algorithm 250 may initiate communications to one or both of a client computer 214, 230 and an application provider computer 232, 234 regarding the renewal status associated with the entitlement. Where so configured, the renewal algorithm 250 may additionally or alternatively reinstate a license or renew an expired license.

A compliance algorithm 248 may be executed by the processor 216 to verify the accuracy of entitlement allocation. For example, the compliance algorithm 248 may compare a total number of applications to which license keys should be allocated to the actual number of entitlement licenses assigned. Where no match is determined, an administrator, a client computer 214, 230, or an application provider 232, 234 may be automatically notified to address the entitlement discrepancy.

An assignment algorithm 252 may be executed by the processor 216 to determine to what application, computing device or user the entitlement data has been assigned. For example, entitlement data may be imported by a client computer 214, 230. The entitlement data may be unassigned at the time the entitlement data arrives at the client computer 214, 230. An administrator at the client computer 214, 230 may assign the entitlement data to inventory data associated with an application, a computing device, or a user. The assignment algorithm 252 may retrieve or otherwise facilitate communication of the inventory data 244, including the assignment information, to the central server computer 202. For example, the inventory data 244 may include a serial number or other data associated with an assignment of a license key. The assignment algorithm 252 may initiate communication of the inventory data 244 from the central server 202 to an application provider 232, 234. The application provider 232, 234 may update entitlement records using the inventory data 244. Entitlement data 236 updated by the application provider 232, 234 may be available for download to the client computer 214 from the central server 202.

The client computer 214 may be similar to the networked computing device 104 of FIG. 1. The client computer 214 may include an application 260, as well as entitlement data 266 used to enable the application 260. Inventory data 262 may be maintained or monitored by the central server 202. A set-up and configuration algorithm 264 may prepare the client computer 214 to interact with the central server 202 and to receive the entitlement data 266. In an embodiment, the set-up and configuration algorithm may automatically apply new entitlement data if it is regenerated because of a change in inventory, e.g., a hardware migration or replacement. The client computer 230 may similarly include an application 270, inventory data 272, a set-up and configuration algorithm 274, and entitlement data 276. The client computer 230 may be configured to automatically apply changes in entitlement data and license information.

The application provider computer 232 may include entitlement data 280 provided to the central server 202 for enabling an application 260, 270 of a client computer 214, 230. The application provider computer 232 may also include inventory data 282 enabled by the entitlement data 280 and associated with the inventory data 262 of the client computer 214, 230 or the application 260, 270. In another embodiment, the application provider computer 232 may have no inventory data and may alternatively access inventory data 244 on the central server 202. The application provider computer 234 may similarly include entitlement data 284 and inventory data 286.

In general, the routines executed to implement the embodiments of the invention, whether implemented as part of an operating system or a specific application, component, program, object, module or sequence of instructions, or even a subset thereof, will be referred to herein as “algorithms,” “program code,” or simply “programs.” Program code typically comprises one or more instructions that are resident at various times in various memory and storage devices in a computer. When read and executed by one or more processors in a computer, the instructions cause that computer to perform the steps used to execute steps or elements of a particular embodiment.

Moreover, while aspects of the invention have and hereinafter will be described in the context of fully functioning computers and computer systems, those skilled in the art will appreciate that the various embodiments of the invention are capable of being distributed as a program product in a variety of forms, and that embodiments of the invention apply equally regardless of the particular type of computer readable media used to actually carry out the distribution. Examples of computer readable media comprise, but are not limited to tangible, recordable type storage media. Examples of tangible, recordable type media include volatile and non-volatile memory devices, floppy and other removable disks, hard disk drives, magnetic tape, and optical disks (CD-ROMs, DVDs, etc.).

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature.

Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

FIG. 2 thus shows an embodiment of another system 200 configured to manage entitlement data in a manner that may store and process license keys and entitlement data of various application providers in a homogenous manner. Such processes may lead to increased efficiency and other economies. The system 200 may automate notifications to customers and application providers concerning entitlement renewal. During a recovery, replacement, or hardware migration scenario, the system 200 may automatically restore entitlement information and license keys to their previous state. In one example, an application provider 232, 234 may be alerted if a portion of a client computer 214 is replaced, migrated or upgraded. The application provider 232 may regenerate entitlement data for the client computer 214 or a replacement to re-obtain.

Those skilled in the art will recognize that the exemplary environments illustrated in FIGS. 1 and 2 are not intended to limit the present invention. Indeed, those skilled in the art will recognize that other alternative hardware and software environments may be used without departing from the scope of the invention.

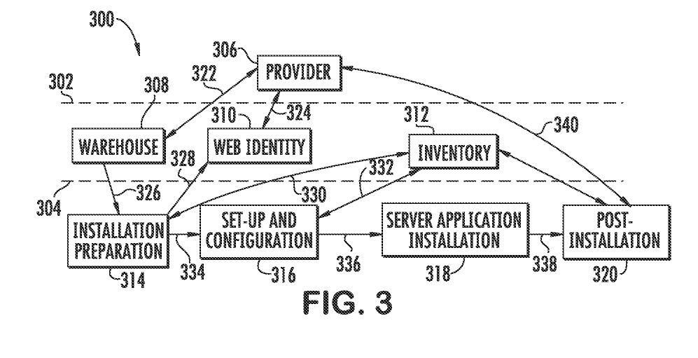

FIG. 3 illustrates a logic diagram 300 that represents a logical relationship between networked computing devices, application providers having entitlement data for enabling applications on the networked computing devices, and a central server maintaining the entitlement data. In one respect, the logic diagram 300 illustrates how a customer, such as the client computer 214, and an application provider, such as the application provider computers 232, 234 of FIG. 2, may interact with a central server and repository, such as the central server 202 of FIG. 2.

In the logic diagram 300, the logical block 306 above dashed line 302 may correspond to application provider processes and components, such as may be associated with the application providers 232, 234 of FIG. 2. Logical blocks 308, 310, and 312, located between dashed lines 302 and 304, may correspond to processes and components of a central server, such as the central server 202 of FIG. 2. Logical blocks 314, 316, 318, and 320, located below dashed lines 304, may correspond to processes and components of networked computing devices, such as the client computers 214, 230 of FIG. 2.

A logical block 306 corresponding to an application provider computer may create an entitlement data file. The logical block 306 may further send via a logical link 322 entitlement data to a logical block 308. The logical block 308 corresponds to an entitlement warehouse. For example, the application provider 234 of FIG. 2 may send entitlement data 284 to the central server 202. As a further example, the central server 202 may create an entitlement data file in memory 218 storing the entitlement data 236.

The logical block 308 may correspond to an entitlement warehouse. For example, the logical block 308 may be similar to the entitlement data 236 stored at the central server 202 of FIG. 2. The entitlement warehouse may generally manage entitlement data assigned to or otherwise associated with a plurality of client computers, users, and various application providers.

The logical block 310 may correspond to Internet web identities associated with users. Users may be assigned to a networked computing device or an application associated with the entitlement data. Administrator may be added, changed and removed post setup. The data associated with the logical block 310 may be included within the inventory data 244 of FIG. 2. A logical link 328 may represent communications adding or subtracting users authorized to receive the entitlement data.

The logical block 312 may correspond to an inventory repository. For example, the logical block 312 may be similar to the inventory repository 242 of FIG. 2. The logical block 312 may generally maintain and manage inventory data, such as the inventory data 244 stored at the inventory repository 242 of FIG. 2.

The logical block 314 may represent installation preparation processes. Entitlement data may not be specific to a server. An administrator at the networked computing device may execute a “Prep for Install” function. The function may map the entitlement data to a specific server from the logical block 308 that represents the entitlement warehouse. The function may further store the mapped assignment within the logical block 312 corresponding to inventory data. For example, the client computer 214 of FIG. 2 may include installation preparation processes that may be used to facilitate entitlement management communications with the central server computer 202. Preparations may be made for an application to be installed on the client computer 214. An administrator may be assigned. In the embodiment of FIG. 3, the logical block 314 may further enable communications with the logical blocks 308, 310, and 312.

The logical block 314 may additionally prompt the logical block 316 associated with set-up and configuration. Processes associated with the logical block 314 may execute a “Set-up and Configuration Wizard” function. The function may retrieve inventory data and entitlement data associated with a networked computing device. For example, the function may monitor or otherwise determine the operational status of a hardware or software component of a client computer. The determined inventory data may be communicated to a central server.

The function may configure the application on the networked computing device based on the entitlement data. For example, the client computer 214 of FIG. 2 may include set-up and configuration processes. The processes may be used to facilitate inventory data monitoring and management by the central server computer 202. The entitlement data may be imported for the application of the client computer. A serial number of the client computer may be recorded within the inventory repository. The logical block 314 may include a logical link 334 to logical block 316 to manage inventory data of the client computer.

The logical block 318 may correspond to components and processes associated with the installation of the application. For example, the application 260 of FIG. 2 may be installed onto the client computer 214. The installation processes may include the activation of the entitlement data to enable the application. Logical link 336 may represent processes initiated to execute the installation of the application. In another embodiment, logical block 318 may communicate directly with either or both logical blocks 306 and 308.

The logical block 320 may represent post-installation components and processes. For example, the logical block 320 may manage updating the central server with regard to any updates concerning additional applications and may automatically check for updated entitlement data available from the central server. For example, updates regarding the installed status and installation data may be accomplished. In another example, the client computer 214 of FIG. 2 may check for updated license keys available to be imported from the central server computer 202. In another embodiment, logical block 320 may communicate directly with logical block 308.

A logical link 338 may include processes associated with transitioning to the post-installation state. A logical link 340 may include processes enabling the client computer to use a deep link connection to receive entitlement data directly from the application provider. For example, a license key required for an application may be unavailable from the entitlement data 236 stored on the central server 202 of FIG. 2. Where the application provider has provided a deep link to the client computer of the customer, the customer may link to the website, web server, or other interface of the application provider to obtain the license key. The license key may then be stored at the central server. For example, the deep link connection may be provided from the central server 202 of FIG. 2 to the client computer 214. The deep link may be used to initiate the license process with the application provider, but the entitlement and license data may still be maintained centrally. The deep link may allow the client computer 214 to receive entitlement data 280 directly from the application provider 232.

FIG. 3 thus illustrates a logic diagram 300 including logical links and functions associated with a central server and repository configured to manage entitlement data associated with a plurality of application providers. The diagram further shows a relationship between a networked computing device, application providers having entitlement data, and a central server and repository. The relationship may facilitate organizational efficiencies and efficient entitlement renewal management.

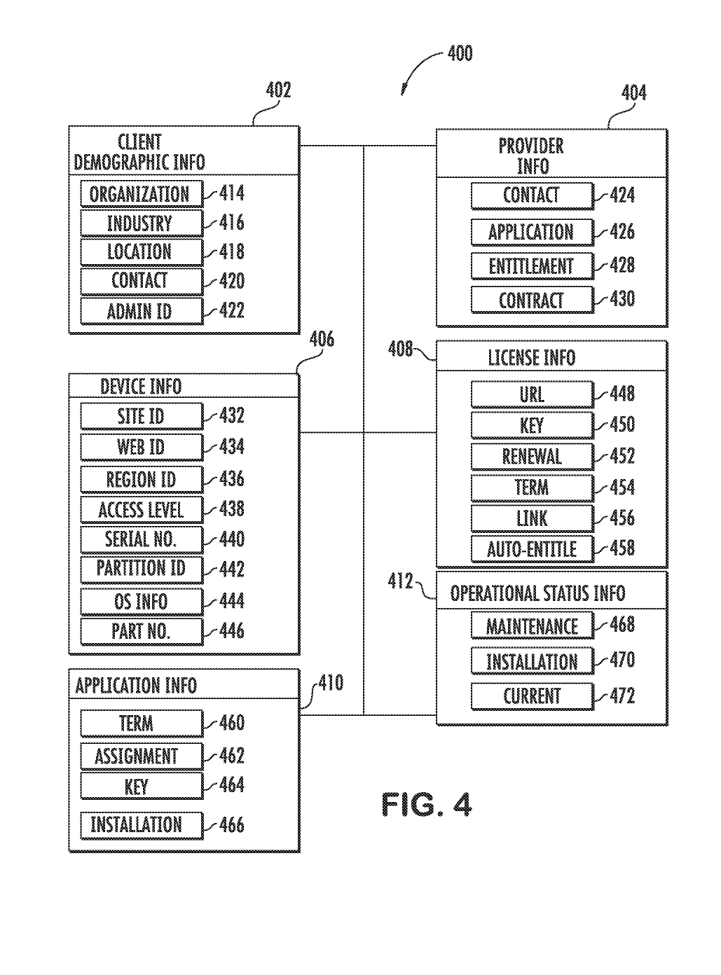

FIG. 4 illustrates a diagram 400 that shows a data model having logically linked data, such as may be stored within the inventory repository 242 and that represents entitlement data 236 of FIG. 2. The diagram 400 shows inventory data arranged according to an embodiment of a database of a central server computer. More particularly, the diagram 400 includes client demographic information 402, application provider information 404, networked computing device information 406, entitlement application license information 408, application information 410, and operational status information 412.

The client demographic information 402 may generally include information related to the client, such as a user operating client computer 214 of FIG. 2. Examples of client demographic information 402 may include organization-related data 414, industry-related data 416, location-related data 418, contact information 420, and information 422 identifying an assigned administrator.

The application provider information 404 may generally include information related to an application provider, such as the application provider 232 of FIG. 2. Examples of application provider information 404 may include contact information 424, application-related data 426, entitlement-related data 428, and contract-related information 430.

The networked computing device information 406 may generally include information related to a networked computing device, such as the client computer 214 of FIG. 2. Examples of networked computing device information 406 may include site identification data 432 and web identification data 434, as well as region identification data 436. The networked computing device information 406 may also include access level data 438, serial number data 440, partition identification data 442, operating system-related information 444, and part number data 446. Other exemplary data (not shown) may relate to an amount of memory, a number of processors, an IP address, an MAC address, and a host name, among others.

The application license information 408 may generally include information relating to an application license purchased by an operator of a networked computing device, such as the client computer 214 of FIG. 2. Examples of application license information 408 may include a uniform resource locator 448 to a license key, a license key 450, and entitlement data renewal information 452. Other examples may include license term information 454, a link 456 to a license key or other entitlement data, and an auto-entitlement component 458 that automatically initiates entitling an added hardware device or user of an application.

The application information 410 may generally include information related to an application configured to be executed by a networked computing device, such as the application 260 of FIG. 2. Examples of the application information 410 may include a term 460 for which an application is entitled, assignment information 462 indicating a user or hardware component to which an application is assigned, a license key 464, and installation-related information 466.

The operational status information 412 may generally include installation or diagnostic data regarding a networked computing device, an application resident on the networked computing device, or a user assigned to the networked computing device, such as the client computer 214 of FIG. 2. Operational status information 412 may include maintenance-related data 468, installation-related data 470, and current/operational status data 472.

FIG. 4 thus shows a data model 400 illustrating exemplary data that may be included within an inventory and entitlement repository. The data model may increase entitlement organization and availability and facilitate automated entitlement management processes that streamline entitlement maintenance.

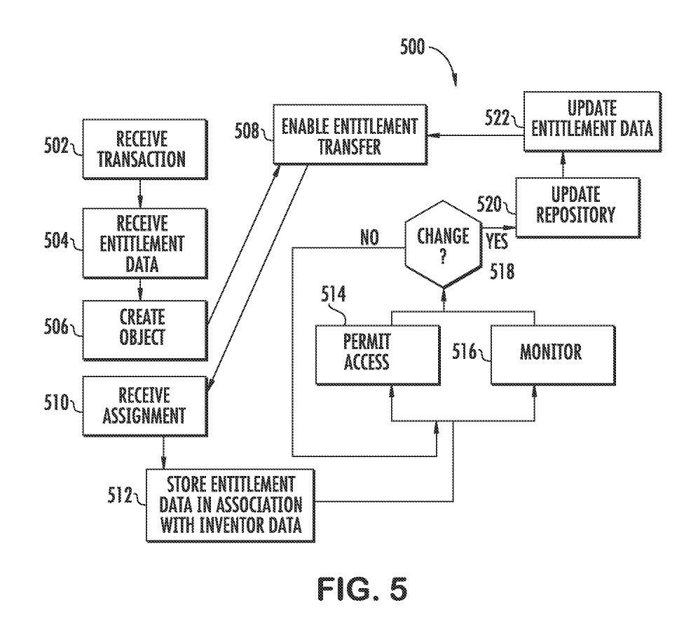

FIG. 5 illustrates a flow chart of a particular embodiment of a method 500 configured to manage inventory data and entitlement data for a plurality of client and application provider computers. The method 500 may be executed by a processor of a central server computer, such as the central server computer 202 of FIG. 2. Transaction information may be received, at 502. For example, the central server 202 of FIG. 2 may receive transaction data 256 from an application provider 234 indicating a purchase of an application 260 or some other change in the inventory data 244.

Entitlement data may be received, at 504. For example, the central server 202 of FIG. 2 may receive entitlement data 236 from an application provider 234. The entitlement data may be configured to enable an application added to a networked computing device, such as the client computer 214 of FIG. 2.

An entitlement object may be created, at 506. For example, the central server 202 of FIG. 2 may create an object storing entitlement data 236 in response to receiving a transaction from the application provider 234.

An entitlement transfer may be enabled, at 508. For example, the central server 202 of FIG. 2 may make entitlement data 236 available to be imported by the client computer 214. In another embodiment, the entitlement data may be downloaded to a networked computing device.

The entitlement data may be unassigned when it is transferred to the networked computing device. For example, an administrator at the networked computing device may assign the entitlement data as desired to a computing device or user(s). In another example, the networked computing device, itself, may automatically assign the entitlement data. The assignment information may be received, at 510. For example, the central server 202 of FIG. 2 may receive inventory data 244 that includes information indicating that an administrator has assigned the entitlement data 266 to the client computer 214.

The entitlement data may be stored in association with the inventory data, at 512. For example, the central server 202 of FIG. 2 may store information associated with the assignment of the entitlement data to a hardware serial number of a client computer 214.

Access may be permitted to the entitlement data, at 514. For example, the central server 202 of FIG. 2 may enable the client computer 214 to import the entitlement data.

The inventory data may be monitored, at 516. For example, the central server 202 of FIG. 2 may monitor inventory data indicating that there has been an addition or a removal of hardware or software, as well as inventory data indicating an operational status of the hardware or software.

Monitoring may continue until a change in the inventory data is detected, at 518. For example, software executing on either or both the client computer 214 and the central server 202 of FIG. 2 may automatically gather operational data associated with a detected failure of a hardware or a software component of the client computer 214.

When a change is detected, the inventory repository may be updated, at 520. For example, the central server 202 of FIG. 2 may update the inventory repository 242 to reflect the detected change.

The entitlement data may be updated, at 522. For example, the central server 202 of FIG. 2 may add, remove, or replace entitlement data 236 according to the detected change in the inventory data. For instance, new entitlement data may be acquired at the central server 202 when a new networked computing device has been added to a system.

The transfer of the updated entitlement data may be enabled, at 508. For example, the central server 202 of FIG. 2 may make the updated entitlement data 236 available for import by a client computer 214.

FIG. 5 thus shows a flowchart of an embodiment of a method 500 configured to manage entitlement data from a plurality of application providers. The method 500 may store and process license keys and entitlement data of the application providers in a similar manner to increase efficiency and other economies. During a recovery, replacement, or migration scenario, the system 500 may automatically restore entitlement information and license keys to their previous state. In such a scenario, processes may automatically initiate so that an application provider may be automatically alerted that a change in inventory has taken place. The application provider may update entitlement data associated with the new inventory.

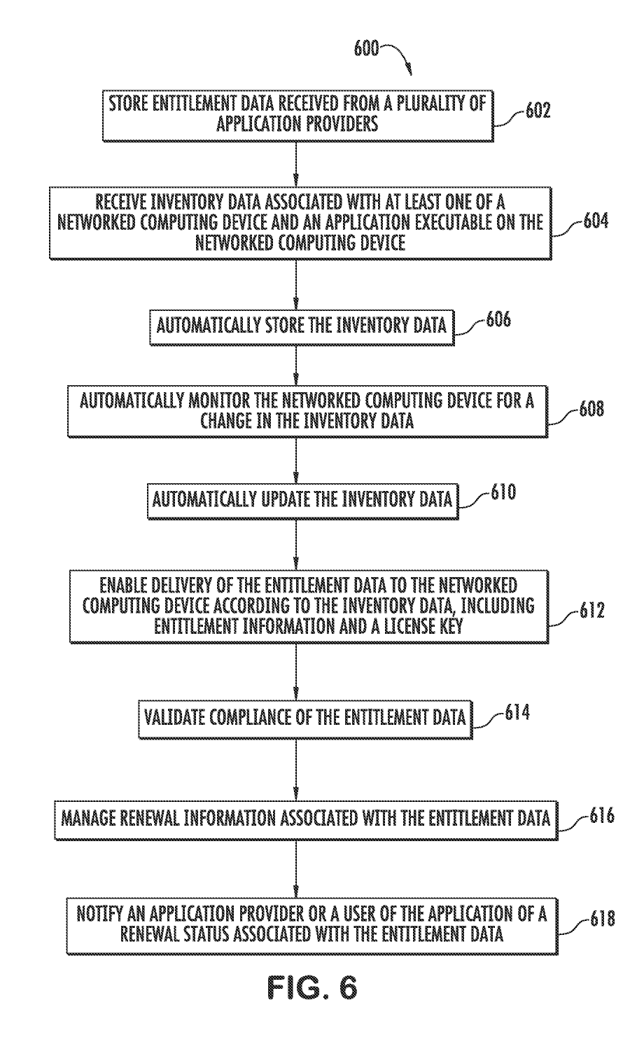

FIG. 6 illustrates a flow chart of an embodiment of a method 600 configured to manage entitlement data from a plurality of application providers. In a particular embodiment, the method 600 may be performed by a central server, such as the central server 202 of FIG. 2.

Turning to the flow chart, the method 600 includes storing entitlement data received from a plurality of application providers, at 602. For example, the central server 202 of FIG. 2 may receive entitlement data 236 from an application provider 234. The entitlement data may be configured to enable an application added to a networked computing device, such as the client computer 214 of FIG. 2.

Inventory data associated with a networked computing device or an application executable on the networked computing device may be received, at 604. For example, the central server 202 of FIG. 2 may receive inventory data from the client computer 214 or the application provider 234. Examples of inventory data may include a hardware identifier, such as a serial number, and a status of a networked computing device, an application, or a user. Other examples of inventory data may relate to a network, as well as features and capabilities of the platform. Other inventory data may include assignment information associating the entitlement data with an application, a user, or a networked computing device.

The inventory data may be automatically stored, at 606. For example, the central server 202 of FIG. 2 may store the inventory data 244 within an inventory repository 242.

The networked computing device may be automatically monitored for a change in the inventory data, at 608. For example, a monitoring algorithm 246 executing on either or both the client computer 214 and the central server 202 of FIG. 2 may automatically gather installation or operational data associated with a detected failure of a hardware or a software component of the client computer 214.

The inventory data may be automatically updated, at 610. For example, the central server 202 of FIG. 2 may update the inventory repository 242 to reflect the detected change.

The delivery of the entitlement data to the networked computing device may be enabled according to the inventory data, at 612. For example, entitlement information and a license key may be made ready for delivery in accordance with received inventory data. The inventory data may indicate that an application (enabled by the entitlement data) has been added. The application may be automatically fulfilled based on the entitlement data. For example, when the entitlement data is assigned to a server, and the server retrieves the entitlement, the application may be automatically retrieved. For example, an application may be automatically retrieved from an application repository.

The compliance of the entitlement data may be validated, at 614. For example, the compliance algorithm 248 of FIG. 2 may compare a total number of applications that should have received license keys to the actual number of license keys issued. Where a match is not determined, an administrator may be automatically notified to address the entitlement discrepancy.

Renewal information associated with the entitlement data may be managed, at 616. For example, the renewal algorithm 250 of FIG. 2 may automatically determine a renewal status associated with an entitlement. For instance, the renewal algorithm 250 may determine if entitlement data is ready or nearly ready for renewal.

An application provider or a user of an application may be notified of a renewal status associated with the entitlement data, at 618. For example, the renewal algorithm 250 of FIG. 2 may initiate communications regarding the entitlement renewal status to one or both of the client computer 214, 230 and at least one of the application provider computers 232, 234.

FIG. 6 thus illustrates a flow chart of an embodiment of a method 600 of managing entitlement data and inventory data. The method 600 may further provide automatic notifications to customers and application providers concerning entitlement renewal. During a recovery scenario, the method 600 may automatically restore entitlement information and license keys to their previous state.

While the present invention has been illustrated by a description of various embodiments and while these embodiments have been described in considerable detail, it is not the intention of the Applicants to restrict, or, in any way limit the scope of the appended claims to such detail. The invention in its broader aspects is therefore not limited to the specific details, representative apparatus and method, and illustrative example shown and described. Accordingly, departures may be made from such details without departing from the scope of Applicants' general inventive concept.

What is claimed is:

1. A method of managing application entitlement data, comprising:
storing entitlement data received from a plurality of application providers;
receiving inventory data associated with at least one of a networked computing device and an application executable on the networked computing device; and
enabling delivery of the entitlement data to the networked computing device according to the inventory data.

2. The method of claim 1, further comprising automatically storing and automatically updating the inventory data.

3. The method of claim 1, further comprising automatically monitoring the networked computing device to detect a change in the inventory data.

4. The method of claim 1, wherein enabling the delivery of the entitlement data further comprises enabling retrieval of the entitlement data by the networked computing device.

5. The method of claim 4, further comprising enabling the networked computer device to retrieve the application.

6. The method of claim 1, further comprising managing renewal information associated with the entitlement data.

7. The method of claim 1, further comprising notifying at least one of an application provider of the plurality of application providers and a user of the application of a renewal status associated with the entitlement data.

8. The method of claim 1, further comprising validating compliance of the entitlement data.

9. The method of claim 1, wherein receiving the inventory data further comprises receiving from an application provider of the plurality of application providers a transaction notification that includes the inventory data.

10. An apparatus, comprising:
a memory configured to store entitlement data received from a plurality of application providers, wherein at least a portion of the entitlement data is configured to enable an application executable on a networked computing device, wherein the memory is further configured to store inventory data associated with the networked computing device;
program code resident within the memory; and
a processor in communication with the memory and configured to execute the program code to enable delivery of the entitlement data to the networked computing device according to the inventory data.

11. The apparatus of claim 10, wherein the processor is further configured to execute the program code to enable the delivery of the entitlement data in response to receiving the inventory data.

12. The apparatus of claim 10, wherein the processor is further configured to execute the program code to identify a change in the inventory data.

13. The apparatus of claim 12, wherein the identified change includes a change in at least one of a status of the application and a status of the networked computing device.

14. The apparatus of claim 10, wherein the inventory data is associated with a user assigned to at least one of the entitlement, the application and the networked computing device.

15. The apparatus of claim 10, wherein the entitlement data includes at least one of entitlement information and a license key enabling use of the application at the networked computing device.

16. The apparatus of claim 10, wherein the inventory data includes a hardware identifier, a serial number, network information, platform information, a status of the networked computing device, a status of another networked computing device, a status of the application, a status of another application, a status of a user assigned to at least one of the application and the networked computing device, and assignment information associating the entitlement data with at least one of the application, a user, and the networked computing device.

17. The apparatus of claim 10, wherein the processor is further configured to execute the program code to enable the delivery of the entitlement data by enabling retrieval of the entitlement data by the networked computing device.

18. The apparatus of claim 10, wherein the processor is further configured to execute the program code to provide the entitlement data by facilitating delivery of the entitlement data to the networked computing device directly from an application provider of the plurality of application providers.

19. The apparatus of claim 10, wherein a common business entity maintains both the apparatus and the networked computing device.

20. The apparatus of claim 10, wherein the processor is further configured to execute the program code to identify a renewal status associated with the entitlement data.

21. The apparatus of claim 10, wherein the inventory data includes assignment information used to assign the entitlement data to at least one of the application, a user, and the networked computing device.

22. The apparatus of claim 10, wherein the processor is further configured to execute the program code to allow an application provider of the plurality of application providers access to the entitlement data associated with the application provider.

23. The apparatus of claim 10, wherein the processor is further configured to automatically restore the entitlement data at the networked computing device in response to a system failure affecting the network computing device.

24. An apparatus, comprising:
a plurality of application provider computers each including entitlement data configured to enable at least one of a plurality of applications;
a client computer including inventory data and an application of the plurality of applications; and
a central server computer configured to monitor the inventory data and to receive the entitlement data from the plurality of application providers, the central server computer further configured to enable delivery of stored entitlement data configured to enable the application at the networked computing device.

25. A program product, comprising:
program code configured to receive entitlement data from a plurality of application providers, wherein at least a portion of the entitlement data is configured to enable an application executable on a networked computing device, wherein the program code is further configured to enable delivery of the entitlement data to the networked computing device according to inventory data associated with the networked inventory device; and
a computer readable medium bearing the program code.
